(19) United States
(12) Patent Application Publication
(10) Pub. No.: US 2022/0086182 A1
(43) Pub. Date: Mar. 17, 2022

(54) RISK-ADAPTIVE DNS FORWARDER

(71) Applicant: Forcepoint LLC, Austin, TX (US)

(72) Inventor: Mattia MAGGIOLI, Cork (IE)

(73) Assignee: Forcepoint LLC, Austin, TX (US)

(21) Appl. No.: 17/020,615

(22) Filed: Sep. 14, 2020

(51) Int. Cl. H04L 29/06; H04L 29/12

(52) U.S. Cl. CPC H04L 63/1433; H04L 61/2007; H04L 61/1511

(57) ABSTRACT

A method, system, and computer-usable medium are disclosed for: (i) receiving, from a client device, a request for an Internet Protocol (IP) address associated with a domain name; (ii) determining a risk score associated with the client device; and (iii) responding to the request, wherein the response is based on the risk score, and wherein the response is selected from the group consisting of: transmitting the IP address associated with the domain name, and not transmitting the IP address associated with the domain name.

### FIELD OF DISCLOSURE

The present disclosure relates in general to the field of computers and similar technologies, and in particular to software utilized in this field. Still more particularly, it relates to a method, system, and computer-readable medium for performing risk-adaptive Domain Name System (DNS) forwarding.

### BACKGROUND

While network communication among networked computers, including the use of the Internet, has many advantages, one downside to network communication is that it may render networked computers susceptible to malicious attacks from viruses or other intrusions. Accordingly, security devices such as network firewalls often analyze information regarding network connections, including information about a user and/or executable program that initiated the connection from the client device.

As one of ordinary skill in the art with the benefit of this disclosure will appreciate, DNS is one of the core protocols that allows computer networks to operate at a global scale by translating human-readable domain names (e.g., example.com) into numerical Internet Protocol (IP) addresses that network devices can use to connect a client machine to the server that hosts the desired resource. However, since its original definition in 1983, DNS has operated in a somewhat simplistic manner: by always responding to DNS queries with the requested IP address (which may either be known by the DNS server receiving the query or be determined by forwarding the query to another DNS server). Because of the simplicity and inflexibility of the DNS protocol, DNS servers typically operate with an immutable logic (e.g., to return the IP address corresponding to the domain name if the information is known to the server), which does not provide the ability to prevent security and productivity issues caused by malicious actors. Typically, DNS servers simply respond to the queries regardless of the identity (and the associated risk profile) of the user or device making the DNS query or the nature of the Internet resource associated with the domain name.

Accordingly, embodiments of this disclosure may provide improvements in the ability of DNS servers to deal with security and/or productivity issues.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, certain disadvantages and problems associated with existing approaches to network and data security have been reduced or eliminated.

In accordance with embodiments of the present disclosure, a computer-implemented method for performing Domain Name System (DNS) communication may include: receiving, from a client device, a request for an Internet Protocol (IP) address associated with a domain name; determining a risk score associated with the client device; and responding to the request, wherein the response is based on the risk score, and wherein the response is selected from the group consisting of: transmitting the IP address associated with the domain name, and not transmitting the IP address associated with the domain name.

In accordance with these and other embodiments of the present disclosure, a system may include at least one processor; and a computer-readable medium embodying instructions executable by the at least one processor for: receiving, from a client device, a request for an Internet Protocol (IP) address associated with a domain name; determining a risk score associated with the client device; and responding to the request, wherein the response is based on the risk score, and wherein the response is selected from the group consisting of: transmitting the IP address associated with the domain name, and not transmitting the IP address associated with the domain name.

In accordance with these and other embodiments of the present disclosure, an article of manufacture may include a non-transitory, computer-readable medium embodying computer program code, the computer program code being executable for: receiving, from a client device, a request for an Internet Protocol (IP) address associated with a domain name; determining a risk score associated with the client device; and responding to the request, wherein the response is based on the risk score, and wherein the response is selected from the group consisting of: transmitting the IP address associated with the domain name, and not transmitting the IP address associated with the domain name.

Technical advantages of the present disclosure may be readily apparent to one having ordinary skill in the art from the figures, description and claims included herein. The objects and advantages of the embodiments will be realized and achieved at least by the elements, features, and combinations particularly pointed out in the claims.

It is to be understood that both the foregoing general description and the following detailed description are explanatory examples and are not restrictive of the claims set forth in this disclosure.

### BRIEF DESCRIPTION OF THE DRAWINGS

A more complete understanding of the example, present embodiments and certain advantages thereof may be acquired by referring to the following description taken in conjunction with the accompanying drawings, in which like reference numbers indicate like features, and wherein:

FIG. 1 illustrates an example information handling system in which the methods and systems disclosed herein may be implemented, in accordance with embodiments of the present disclosure;

FIG. 2 illustrates a block diagram of a system for performing risk-adaptive DNS forwarding, in accordance with embodiments of the present disclosure; and

FIG. 3 illustrates a block diagram of a system for performing risk-adaptive DNS forwarding, in according with embodiments of the present disclosure.

### DETAILED DESCRIPTION

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a mobile device such as a tablet or smartphone, a consumer electronic device, a connected “smart device,” a network appliance, a network storage device, a network gateway device, a server or collection of servers or any other suitable device and may vary in size, shape, performance, functionality, and price. The information handling system may include volatile and/or non-volatile memory, and one or more processing resources such as a central processing unit (CPU) or hardware or software control logic. Additional components of the information handling system may include one or more storage systems, one or more wired or wireless interfaces for communicating with other networked devices, external devices, and various input and output (I/O) devices, such as a keyboard, a mouse, a microphone, speakers, a track pad, a touchscreen and a display device (including a touch sensitive display device). The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or solid state drive), a sequential access storage device (e.g., a tape disk drive), optical storage device, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

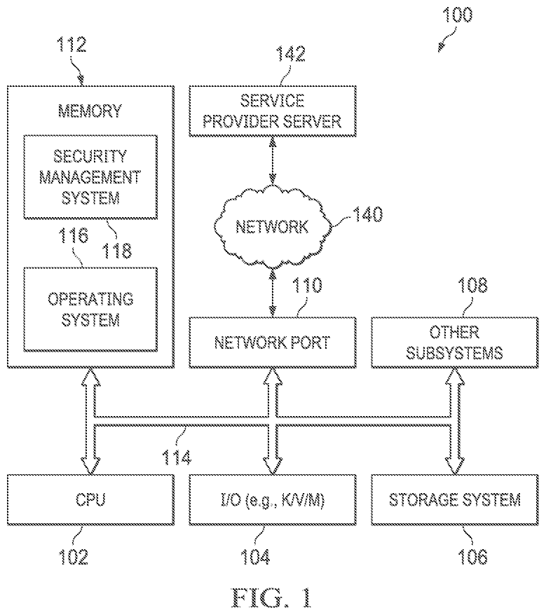

FIG. 1 illustrates an example information handling system 100 in which the methods and systems disclosed herein may be implemented, in accordance with embodiments of the present disclosure. Information handling system 100 may include a processor (e.g., central processor unit or “CPU”) 102, input/output (I/O) devices 104 (e.g., a display, a keyboard, a mouse, and/or associated controllers), a storage system 106 (e.g., a computer-readable medium such as a non-transitory computer-readable medium), and various other subsystems 108. In various embodiments, information handling system 100 may also include network port 110 operable to couple to a network 140, which may likewise be accessible by a service provider server 142. Information handling system 100 may also include system memory 112, which may be coupled to the foregoing via one or more buses 114. System memory 112 may store operating system (OS) 116 and in various embodiments may also include a security management system 118. In some embodiments, information handling system 100 may be able to download security management system 118 from service provider server 142. In other embodiments, security management system 118 may be provided as a service from the service provider server 142.

In various embodiments, security management system 118 may be configured to enable risk-adaptive DNS forwarding, as described in greater detail below. In some embodiments, security management system 118 and the functionality thereof may improve processor efficiency, and thus the efficiency of information handling system 100, by performing network security operations with greater efficiency and with decreased processing resources as compared to existing approaches for similar network security operations. In these and other embodiments, security management system 118 and the functionality thereof may improve effectiveness in ensuring network security, and thus the effectiveness of information handling system 100, by performing network security operations with greater effectiveness as compared to existing approaches for similar network security operations. As will be appreciated, once information handling system 100 is configured to perform the functionality of security management system 118, information handling system 100 becomes a specialized computing device specifically configured to perform the functionality of security management system 118, and is not a general purpose computing device. Moreover, the implementation of functionality of security management system 118 on information handling system 100 may improve the functionality of information handling system 100 and provide a useful and concrete result of improving network security and performing network security operations with greater efficiency and with decreased processing resources.

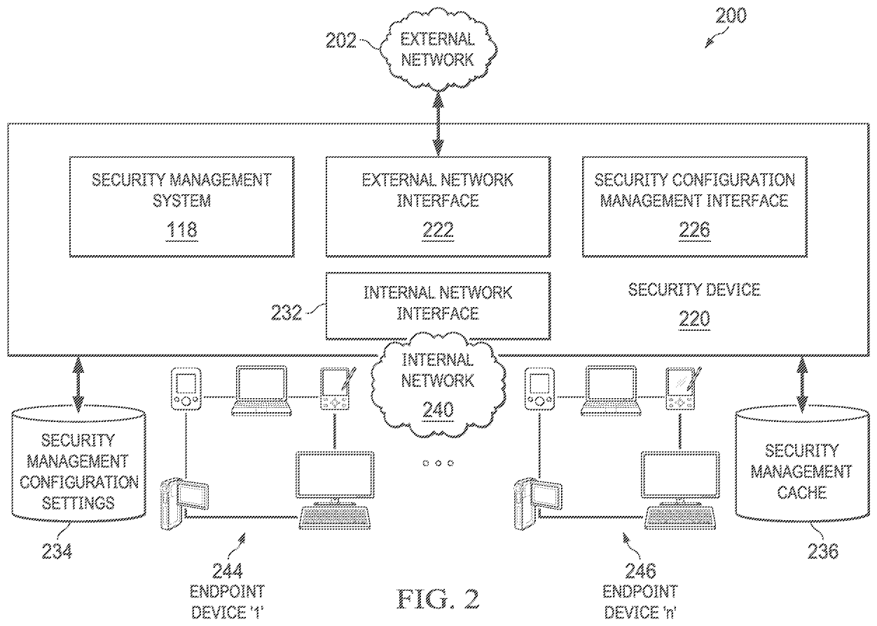

FIG. 2 illustrates a block diagram of a system 200 for performing risk-adaptive DNS forwarding, in accordance with embodiments of the present disclosure. In some embodiments, a security device 220 may include an external network interface 222, a security configuration management interface 226, an internal network interface 232, and a security management system 118. Security device 220 may be implemented using any suitable information handling system 100, including without limitation a server, a gateway, a firewall, an intrusion prevention system, an intrusion detection system, or any other suitable security device capable of implementing security management system 118. In some embodiments, security device 220 may be implemented as an individual security device 220, a virtual context security device 220, or a security device 220 cluster.

Security device 220 may also include in some embodiments a repository of security management configuration settings 234 and a security management cache 236. In certain embodiments, security configuration management interface 226 may be implemented to receive instructions relating to network security policy decisions from security management system 118.

Skilled practitioners of the art will be familiar with network communication involving communicating Internet Protocol (IP) datagrams, or packets, to a target group of recipient network addresses in real-time or near real-time. In some embodiments, the target group recipient network addresses may be respectively associated with a corresponding endpoint device ‘1’ 244 through ‘n’ 246. As used herein, an endpoint device refers to an information processing system such as a personal computer, a laptop computer, a tablet computer, a smart phone, a mobile telephone, a digital camera, a video camera, or other device capable of storing, processing and communicating data via a network, such as an internal network 240 interfaced to internal network interface 232. In various embodiments, the communication of the data may take place in real-time or near-real-time.

Embodiments of this disclosure may reflect an appreciation that network communication may represent an efficient means for communicating useful information. However, those of skill in the art will likewise appreciate that it may be desirable to secure such network communication to prevent malicious attacks on network components. Many existing solutions for providing security in a network environment have disadvantages, as described in the Background section of this application. However, security management system 118 as disclosed herein may overcome these disadvantages by enabling risk-adaptive DNS forwarding, as described herein.

In some embodiments, security device 220 may implement a DNS server (e.g., an authoritative DNS server, a caching DNS server, a forwarding DNS server, etc.). In some embodiments, security device 220 may be configured to receive DNS requests from any of endpoint devices ‘1’ 244 through ‘n’ 246 via internal network interface 232 and service those requests (for example, by communicating with other DNS server(s) via external network interface 222). Additionally or alternatively, security device 220 may be configured to receive DNS requests from external systems via external network interface 222.

In particular, security device 220 may implement a risk-adaptive DNS forwarder capable of forwarding inbound DNS queries. However, the risk-adaptive DNS forwarder may include forwarding logic that may be controlled by one or more configurable factors to determine which DNS queries are responded to, and in what manner Such factors may include, for example:
1. Risk information associated with the source device (or a user of the source device) for the DNS query. For example, a value of 1 to 10 may be used as a risk score in some implementations, such that 1 indicates a low-risk source and 10 indicates a source that is known to be malicious. Such risk information may be derived from a variety of sources. For example, if the source device is a mobile device, a Subscriber Identification Module (SIM) card or a phone number associated with the device may be used for such purposes. As another example, the source device may have a way of securely providing an identity of a user of the device (e.g., via a login, etc.). The risk score may thus be associated with the user that is associated with the client device (e.g., as determined at the time of the DNS query). In these and other embodiments, a risk score provider such as a security company, a credit score aggregator, etc. may provide input from which the risk score may be derived. Various other ways of determining a risk score will also be apparent to one of ordinary skill in the art with the benefit of this disclosure.
2. A mapping of domain names to predefined categories of service type (e.g., malicious sites, suspicious sites, social networking sites, streaming services, file sharing services, sensitive services such as banking sites, etc.).
3. Lists of domain names (or IP addresses) such as a safelist of domain names that are always trusted or a blocklist of IP addresses that should never be provided upon the resolution of a domain name). Such lists may in some embodiments be provided by a data feed from an external service, be configurable by a user, etc.

Thus some embodiments may enable extremely flexible risk-adaptive DNS resolution that may prevent a user/device from reaching a particular Internet resource based on one or more factors that are available to the DNS forwarder. For example, such a system may be used in order to implement outcomes such as the following examples:
1. Resolution of a domain name based on the risk profile of the user and the category of the domain name (e.g. resolving the address for a file sharing site for a low-risk user, but not resolving the same site for a high-risk user in order to avoid data exfiltration).
2. Resolution of a domain name of a social networking site if the query is sent outside of business hours, but not resolving the same site during business hours.
3. Resolution of a domain name if the source IP is within a trusted list of sources (e.g., IP addresses of remote offices).
4. Preventing the response to the DNS query (even though the risk profile and categorization would otherwise allow the response) based on a determination that the resulting IP address is blocklisted by the user or by an external feed of blocklisted addresses.

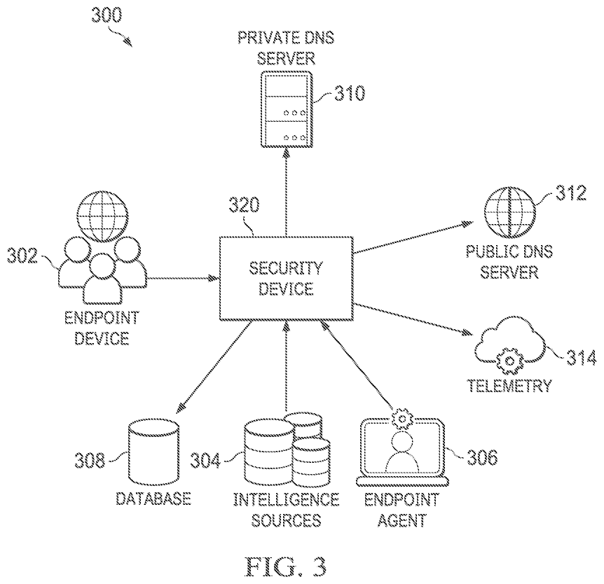

FIG. 3 illustrates a block diagram of a system 300 for performing risk-adaptive DNS forwarding, in accordance with embodiments of the present disclosure. Security device 320 (which may be generally similar to security device 220 discussed above) may receive a DNS query from an endpoint device 302. The DNS query may seek to determine an IP address associated with a given domain name.

As noted above, the risk-adaptive DNS forwarding of the present disclosure may be flexible and configurable based on the needs of a particular installation. Configuration details may be stored in database 308, and the response of security device 320 may be tuned by adjusting the values of various configuration variables therein. For example, database 308 may indicate parameters such as trusted or untrusted IP addresses or ranges, trusted or untrusted domain names, desired DNS servers for name resolution, business hours, categories of service types, etc. as discussed above.

Intelligence sources 304 may provide inputs regarding the domain name and/or IP address associated therewith. For example, intelligence sources 304 may indicate what service type the domain name is associated with, etc. Intelligence sources 304 may include any suitable source of information, including without limitation data feeds from one or more third parties.

Endpoint agent 306 may provide input regarding the risk score associated with endpoint device 302 and/or a user thereof.

Private DNS server 310 may be used for trusted endpoint devices 302 such that internal domain names may be resolved. Public DNS server 312 may be used for external domain names and/or untrusted endpoint devices 302.

Based on the configuration in database 308 and the various data source inputs, security device 320 may determine how to respond to the query from endpoint device 302. For example, if a source IP address associated with endpoint device 302 is trusted and the requested domain name is within a known set of internal domains, the request may be serviced by forwarding it to private DNS server 310.

Alternatively, if the source IP address is not trusted, additional configuration logic in database 308 may be applied. If the domain is categorized as malicious, then an error code such as NXDOMAIN, SERVFAIL, REFUSED, etc. may be returned. In other embodiments, the query may be silently dropped instead of returning an error code.

If the requested domain matches a particular service type category that is not malicious, then the request may be serviced (or not serviced) based on additional criteria. For example, the risk score associated with the requesting endpoint device 302, the time of day, and various other criteria as specified in database 308 may all be factors in determining whether and how to service the request.

As a fallback option, if the requester is not trusted but also not malicious, and the requested domain does not match any known category, then the request may be forwarded to public DNS server 312.

Finally, telemetry 314 may store any suitable information in a log. For example, telemetry 314 may store information such as the date and time of the request, the source IP address, the requested domain name, a user identifier associated with endpoint device 302, a risk score, the response, etc.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor(s) to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

1. A computer-implemented method for performing Domain Name System (DNS) communication, comprising:
receiving, from a client device, a request for an Internet Protocol (IP) address associated with a domain name;
determining a risk score associated with the client device; and
responding to the request, wherein the response is based on the risk score, and wherein the response is selected from the group consisting of: transmitting the IP address associated with the domain name, and not transmitting the IP address associated with the domain name;
wherein the response is further based on a service type associated with the domain name and a time at which the request is received, such that for a service type including non-business activity and a time occurring during business hours, the response is not transmitting the IP address associated with the domain name.

2. The method of claim 1, wherein the risk score associated with the client device is a risk score associated with a user of the client device.

3. The method of claim 1, wherein the client device comprises a Subscriber Identification Module (SIM) card, and wherein the risk score associated with the client device is based at least in part on the SIM card.

4. The method of claim 1, further comprising:
transmitting information associated with the client device to a risk score provider; and
receiving the risk score from the risk score provider.

5. The method of claim 4, wherein the risk score provider comprises a credit score aggregator.

6-7. (canceled)

8. A system comprising:
at least one processor; and
a computer-readable medium embodying instructions executable by the at least one processor for:
receiving, from a client device, a request for an Internet Protocol (IP) address associated with a domain name;
determining a risk score associated with the client device; and
responding to the request, wherein the response is based on the risk score, and wherein the response is selected from the group consisting of: transmitting the IP address associated with the domain name, and not transmitting the IP address associated with the domain name;
wherein the response is further based on a service type associated with the domain name and a time at which the request is received, such that for a service type including non-business activity and a time occurring during business hours, the response is not transmitting the IP address associated with the domain name.

9. The system of claim 8, wherein not transmitting the IP address associated with the domain name comprises dropping the request.

10. The system of claim 8, wherein not transmitting the IP address associated with the domain name comprises transmitting an error code to the client device.

11. The system of claim 10, wherein the error code is selected from the group consisting of NXDOMAIN, SERVFAIL, and REFUSED.

12. (canceled)

13. The system of claim 8, wherein the client device is configured to securely provide an identity of a user of the client device, and wherein the risk score associated with the client device is based on the identity of the user of the client device at a time of the request for the IP address.

14. An article of manufacture comprising a non-transitory, computer-readable medium embodying computer program code, the computer program code being executable for:
receiving, from a client device, a request for an Internet Protocol (IP) address associated with a domain name;
determining a risk score associated with the client device; and
responding to the request, wherein the response is based on the risk score, and wherein the response is selected from the group consisting of: transmitting the IP address associated with the domain name, and not transmitting the IP address associated with the domain name;
wherein the response is further based on a service type associated with the domain name and a time at which the request is received, such that for a service type including non-business activity and a time occurring during business hours, the response is not transmitting the IP address associated with the domain name.

15. The article of claim 14, wherein the risk score associated with the client device is a risk score associated with a user of the client device based on an identity of the user of the client device.

16. The article of claim 14, wherein the client device comprises a Subscriber Identification Module (SIM) card, and wherein the risk score associated with the client device is based at least in part on the SIM card.

17. The article of claim 14, wherein the computer program code is further executable for:
transmitting information associated with the client device to a risk score provider; and
receiving the risk score from the risk score provider.

18. The article of claim 17, wherein the risk score provider comprises a credit score aggregator.

19-20. (canceled)
